(19) United States
(12) Patent Application Publication
(10) Pub. No.: US 2012/0329426 A1
(43) Pub. Date: Dec. 27, 2012

(54) SYSTEM AND METHOD FOR MONITORING THE SECURITY OF CELLULAR DEVICE COMMUNICATION

(76) Inventors: Daniel KARIO, Ein Sarid (IL); Nir Levy, Hod Hasharon (IL)

(21) Appl. No.: 13/534,069

(22) Filed: Jun. 27, 2012

Related U.S. Application Data
(60) Provisional application No. 61/501,508, filed on Jun. 27, 2011.

(51) Int. Cl. H04W 12/00; H04W 12/12

(52) U.S. Cl. 455/410

(57) ABSTRACT

System and method for monitoring security status of an inspected cellular device engaged in a cellular network are disclosed. Status parameters related to the inspected cellular device are gathered and analyzed. A security status of the inspected cellular device is determined based on the analysis.

### CROSS REFERENCE TO RELATED APPLICATIONS

This application claims the benefit of U.S. Provisional Application Ser. No. 61/501,508, filed on Jun. 27, 2011 and entitled SYSTEM AND METHOD FOR MONITORING THE SECURITY OF MOBILE DEVICE COMMUNICATION, the entire content of which is incorporated herein by reference.

### FIELD OF THE INVENTION

Embodiments of the invention relate to mobile radio telephone systems and more particularly to method and system for monitoring and enhancing the security of such systems.

### BACKGROUND OF THE INVENTION

A cellular device, also referred to as a mobile phone, cellular phone, cell phone, handset and a hand phone is a device that may connect to a cellular network in order to make and receive telephone calls over a radio link whilst moving around a wide geographic area.

Recent closed and open source technologies together with large public knowledge base of Global System for Mobile Communications (GSM) technology have made the task of building effective tools for mobile communication, and in particular GSM based communication, eavesdropping and location tracking much easier and cheaper. For example, the GSM specification requires the cellular device to authenticate to the network with which it communicates, but does not require the network to authenticate to the cellular device. This forms a security issue that may be exploited for unauthorized eavesdropping.

Additionally, there has been further influx of Viruses, Trojan horses, and other “Spy Phone” software, which may be easily installed by unauthorized third-party on most modern mobile units and devices without authorization from the owner of the cellular device. Evidently, it is possible that large number of mobile devices could be listened at, tracked, and hacked without their owner knowing or consent. Until today there is no tool or technology that can effectively detect and alert when the above is being attempted. Since there is no detection, it is also impossible to centrally govern, coordinate, alert, and control all cell users.

### SUMMARY OF THE INVENTION

According to embodiments of the present invention, there is provided a method for monitoring security status of a cellular device engaged in a cellular network, the method may include: gathering status parameters related to the cellular device; analyzing the status parameters; and determining the security status of the cellular device based on the analysis.

Furthermore, according to embodiments of the present invention, the status parameters may be selected form a list including: cell identification, cell label network identification, cell signal strength, primary scrambling code, location of the cell, Location Area Code, position of the cellular device, status of an operating system of the cellular device and link status and kernel hooks.

Furthermore, according to embodiments of the present invention, analyzing the status parameters may be performed using at least one analysis and machine decision making methods, the analysis and machine decision making methods are selected from the list consisting of: rule based system and machine learning methods.

Furthermore, according to embodiments of the present invention, determining the security status may include integrating results of the at least one analysis and machine decision making methods to a unified indication.

Furthermore, according to embodiments of the present invention, the machine learning methods may be selected from a list including: support vector machines and hidden Markov models.

Furthermore, according to embodiments of the present invention, analyzing the status parameters may include: analyzing the status parameters using a rule based system; analyzing the status parameters using a support vector machine; and analyzing the status parameters using a hidden Markov model.

Furthermore, according to embodiments of the present invention, determining a security status may include integrating the results of the rule based system, the support vector machine and the hidden Markov model to a unified indication.

Furthermore, according to embodiments of the present invention, the rules of the rules based system may be selected from the list including:

rule 1: a cell is faked if its “Cell Identification” parameter contains a known identification of a faked cell,

rule 2: a cell is faked if its signal strength is higher than signal strength of other cells,

rule 3: a cell is faked if its “Cell Identification” parameter contains a known identification of a true cell and its Location parameter does not match a known area in which the true cell having that “Cell Identification” is known to be, and

rule 4: a cell is faked if its “a-normal” score is more than C2 times the “a-normal” score of other cells, where the “a-normal” score is calculated as a weighted sum of the indicators from the rules 1 to 3.

Furthermore, according to embodiments of the present invention, analyzing the status parameters using the support vector machine may include: obtaining a runtime support vector engine comprising a decision file generated during a learning phase; converting the status parameters into feature matrices using a set of rules; and feeding the feature matrices into the runtime support vector engine.

Furthermore, according to embodiments of the present invention, analyzing the status parameters using the hidden Markov model may include: obtaining a hidden Markov model module comprising a decision file generated during a learning phase; converting the status parameters into feature matrices using a set of rules; feeding the feature matrices into hidden Markov model module as runtime observations; and determining a current state of the hidden Markov model module.

Furthermore, according to embodiments of the present invention, the method may include alerting a user of the cellular device in case of an attack.

According to embodiments of the present invention there is provided a data processing system, the system may include: a processor; and a computer usable medium connected to the processor, wherein the computer usable medium contains a set of instructions for monitoring security status of a cellular device engaged in a cellular network, wherein the processor may be designed to carry out a set of instructions to: gather status parameters related to the cellular device; analyze the status parameters; and determine a security status of the cellular device based on the analysis.

Furthermore, according to embodiments of the present invention, the processor may be designed to carry out a set of instructions to analyze the status parameters using at least one analysis and machine decision making methods, the analysis and machine decision making methods may be selected from a list including: rule based system and machine learning methods

Furthermore, according to embodiments of the present invention, the processor may be designed to carry out a set of instructions to determine the security status by integrating results of the at least one analysis and machine decision making methods to a unified indication.

Furthermore, according to embodiments of the present invention, the processor may be designed to carry out a set of instructions to analyze the status parameters by: analyzing the status parameters using a rule based system; analyzing the status parameters using a support vector machine; and analyzing the status parameters using a hidden Markov model.

Furthermore, according to embodiments of the present invention, the processor may be designed to carry out a set of instructions to determine a security status by integrating the results of the rule based system, the support vector machine and the hidden Markov model to a unified indication.

Furthermore, according to embodiments of the present invention, the processor may be designed to carry out a set of instructions to analyze the status parameters using the support vector machine by: obtaining a runtime support vector engine comprising a decision file generated during a learning phase; converting the status parameters into feature matrices using a set of rules; and feeding the feature matrices into the runtime support vector engine.

Furthermore, according to embodiments of the present invention, the processor may be designed to carry out a set of instructions to analyze the status parameters using the hidden Markov model by: obtaining a hidden Markov model module comprising a decision file generated during a learning phase; converting the status parameters into feature matrices using a set of rules; feeding the feature matrices into hidden Markov model module as runtime observations; and determining a current state of the hidden Markov model module.

Furthermore, according to embodiments of the present invention, the processor may be designed to further carry out a set of instructions to alert a user of the cellular device in case of an attack.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram illustrating a system for monitoring the security of a cellular device according to embodiments of the present invention;

FIG. 2 is a flowchart illustration of a method for monitoring the security of a cellular device according to embodiments of the present invention;

FIG. 3 is a flowchart illustration of an exemplary method for analyzing the status parameters and detecting the security status of the inspected cellular device according to embodiments of the present invention;

FIG. 4 is a flowchart illustration of an exemplary rule-based method for data analysis and decision making according to embodiments of the present invention;

FIG. 5 is a flowchart illustration of an exemplary dynamic method for data analysis and decision making according to embodiments of the present invention; and

FIG. 6 which is a flowchart illustration of an exemplary HHM method for data analysis and decision making according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

Devices, systems and methods incorporating aspects of embodiments of the invention are suitable for cellular network applications. Embodiments of the invention may be implemented in conjunction with hardware and/or software adapted to interact with a cellular networks of various technologies, for example, Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), and Integrated Digital Enhanced Network (iDEN).

As used herein security status of cellular device may refer to the cellular phone being attacked or not. An “attack” may refer to an unauthorized activity performed on a cellular device by an unauthorized party. An attack may include, inter alia, eavesdropping e.g. International Mobile Subscriber Identity (IMSI) catchers/man in the middle attack for GSM networks, installations of malicious software such as Viruses, Trojans horses, and other “Spy Phone” software, Bluetooth hack, etc.

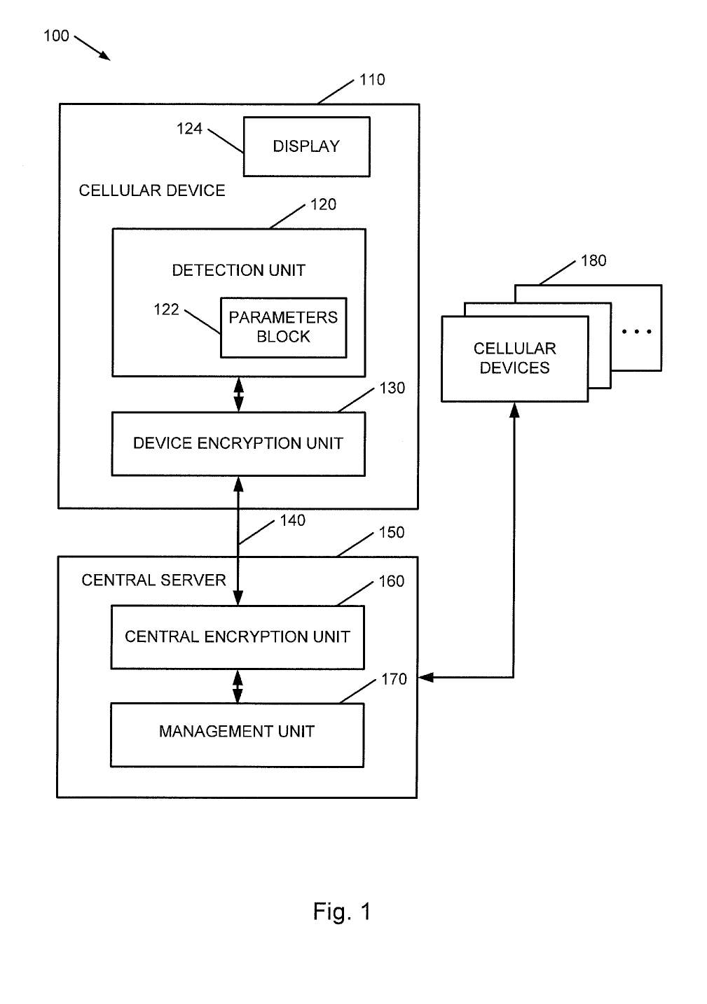

Reference is made to FIG. 1 depicting a schematic diagram illustrating a system 100 for monitoring the security of a cellular device 110 according to embodiments of the present invention. It will be appreciated by those skilled in the art that the simplified components schematically illustrated in FIG. 1 are intended for demonstration purposes only, and that other components may be required for operation of the cellular devices, as known in the art. Those of skill in the art will further note that the connection between components in a cellular device need not necessarily be exactly as depicted in the schematic diagram.

According to embodiments of the present invention, system 100 may include a cellular device 110 and optionally central server 150. Cellular device 110 may include detection unit 120 for detecting a change in the security status of the device, for example for detecting an attack on cellular device 110. Central server 150 may support managing a number, from 1 to millions or more of cellular devices 180 such as cellular device 110.

Central server 150 may gather information from cellular devices 110 and 180, analyze the gathered information and present the information to a user, using any suitable presentation means as know in the art. For example, Central server 150 may present, among other information, online reports to show attacked (e.g. eavesdropped) devices and geographical areas on a map in which cellular devices are being attacked, History tracking and physical path marking (e.g. marking of the route through which an attacking device may access cellular device within a cellular network), Real time alerts when suspected activity is detected, and for law enforcement agencies or other legitimate agencies—ability to “white list” legitimate IMSI catchers for a given area—that is, to identify legitimate IMSI catchers that should not be warned about to the user of cellular device 110.

To enhance the security of system 100, cellular device 110 may optionally include a device encryption unit 130 and central server 150 may include a central encryption unit 160 to establish a secured communication channel 140 between cellular device 110 and central server 150, using secured protocols for control and management. Communication channel 140 may include, or operate by a set of secure traffic protocols for management and control of cellular device 110, and in particular with the respective detection unit 120. Authenticated and encrypted traffic may be transferred through communication channel 140 between central server 150 and cellular device 110 to control and monitor the behavior of detection unit 120 by central server 150, to update software modules of detection unit 120 by central server 150 in real time, and to gather information by central server 150 from one or more of the cellular devices 110 and 180.

Detection unit 120 may perform detection and decision operations by inspecting in real time various status parameters gathered by parameters block 122. The status parameters may be gathered from various sources such as the cellular network (not shown), cellular device 110, etc. For example, parameters block 122 may gather status parameters from the cellular network (not shown) via a modem, GPS or other units. These status parameters may include, inter alia, Location Area Code (LAC), cell signal strength, cell label, location of the cell (retrieved from either the GPS or inform the modem of cellular device 110) etc. Additionally or alternatively, parameters block 122 may gather status parameters from the operating system (OS) of cellular device 110. For example, parameters block 122 may gather status parameters from files, kernel hooks, etc. of OS) of cellular device 110. Additionally or alternatively, parameters block 122 may gather status parameters from data and applications on cellular device 110, as well as from other sources.

Detection unit 120 may analyze values of current and past (“historic”) status parameters and may determine, based on the analysis, the security status of cellular device 110. For example, detection unit 120 may decide based on the analysis of the status parameters which call attempt, software download, or any other activity being preformed by or on cellular device 110 is legitimate, and which constitutes or is suspected to be an attack. For example, detection unit 120 may decide if a request for authentication received from a cell in legitimate or is it a part of a man-in-the-middle attack, if a call received by cellular device 110 is a legitimate call or a faked call which is part of an attack, if an installation of software on cellular device 110 is legitimate or unauthorized etc.

The operations used for the detection may include various analysis and machine decision making methods such as rule based system, learning methods, using for example, support vector machines (SVM), and hidden Markov models (HMM). The decision may be made by running one or more computing processes in parallel, and deciding based on some linear or nonlinear functions and relations between the results of the computing processes. Upon detection of an attack or suspected attack, detection unit 120 may give an indication or alert to a user of cellular device 110, for example, by presenting an appropriate warning on display 124. Additionally or alternatively, detection unit 120 may give an indication or alert to a user of cellular device 110, by any appropriate means such as sending an e-mail to a predetermined address, by sounding an alarm etc. A notification may be sent to central server 150 as well.

It should be readily understood by those skilled in the art that functionality of system 100 may be performed by units other than those described above. For example, parameters block 122 may gather status parameters and send the gathered parameters to central server 150 or to another processing unit such as a personal computer (PC, not shown) for further analysis. Similarly, some status parameters may be gathered by central server 150 or by other components of the cellular network, such as by other cellular devices 180, and transferred, for example, to detection unit 120 for further analysis.

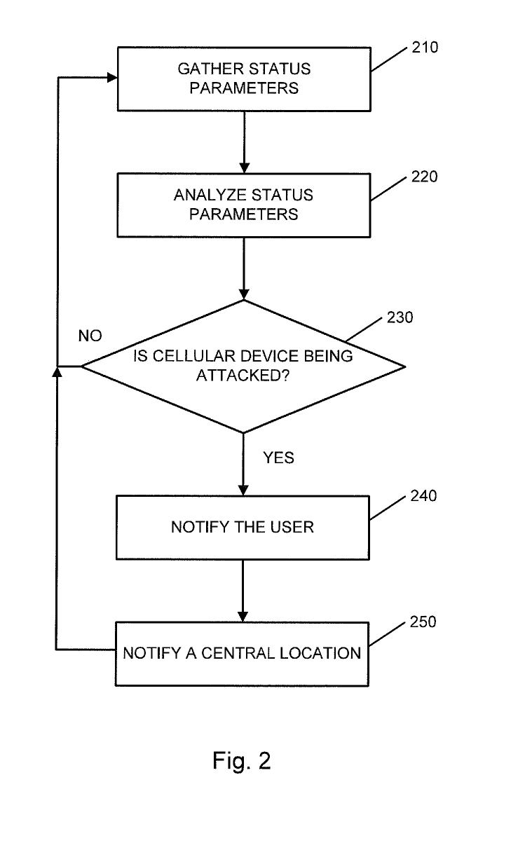

Reference is now made to FIG. 2 which is a flowchart illustration of a method for monitoring the security of a cellular device according to embodiments of the present invention. According to embodiments of the present invention, status parameters may be gathered, as indicated in block 210. In block 220 the status parameters may be analyzed to detect the security status of the inspected cellular device (e.g. cellular device 110). In block 230 security status of the monitored cellular device is determined. The parameters may be analyzed, and the security status may be determined using various data analysis and decision making processes, including, for example, rule based systems, machine learning methods such as neural networks, support vector machines (SVM), Hidden Markov models (HMM), etc. A security status may be determined by running one or more data analysis and decision making processes in parallel, and integrating the results to a unified indication based on relations between outcomes of the processes. A non-binding example of such analysis will be given hereinbelow. If no attack is tracked or suspected, indicated as indicated on block 230, the cellular device is continued to be examined and no warning is issued. In some embodiments, an “OK status” sign may be presented to the user of the inspected cellular device. The process of gathering parameters and monitoring the security of a cellular device may be repeated periodically at predetermined intervals and/or may be initiated by predetermined triggers such as receiving a cell, a software download attempt etc. If an attack is suspected, the user may be notified, as indicated in block 240. Additionally, a notification may be sent to a central location such as central server 150.

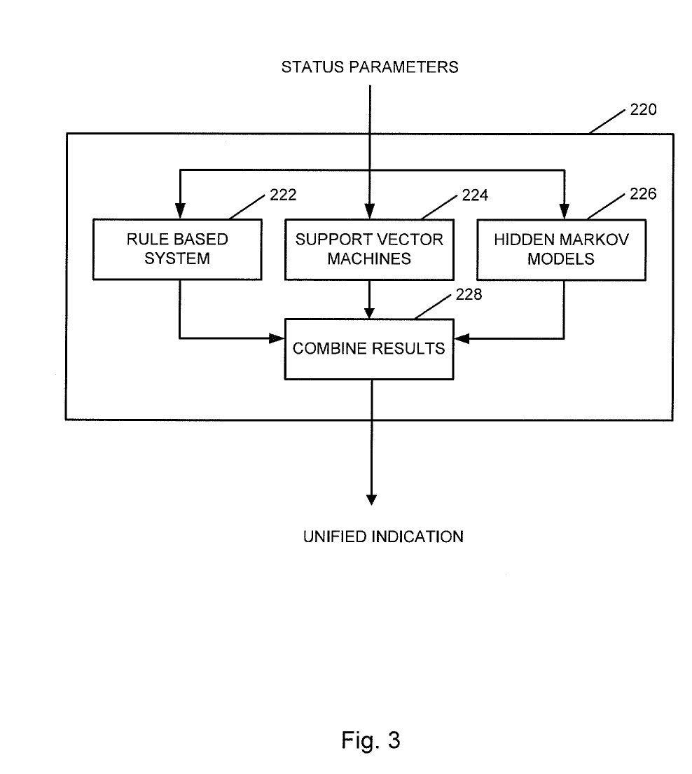

Reference is now made to FIG. 3 which is a flowchart illustration of an exemplary method for analyzing the status parameters and detecting the security status of the inspected cellular device according to embodiments of the present invention. The method presented in FIG. 3 may be an elaboration of block 220 presented in FIG. 2. According to embodiments of the present invention, three data analysis and decision making processes may be used: a rule based system, as indicated in block 222, a support vector machine (SVM) as indicated in block 224 and Hidden Markov model (HMM), as indicated in block 226. All data analysis and decision making processes 222, 224 and 226 may obtain as inputs the status parameters, or a subset of the status parameters, and each of the data analysis and decision making processes 222, 224 and 226 may generate an indication of the security status of the inspected cellular device. The three indications may be combined to a unified security indication in block 228. The final decision on the security status of the inspected cellular device may be taken in real time, using, for example, a function that may integrate the results of one or more of the decision making processes 222, 224 and 226, and then decide on the current unified security indication. For example, the function may be a sum of the results, an average or a weighted average of the results, or any other suitable operation taken on the results of the decision making processes 222, 224 and 226, followed by comparison of the final result to a threshold level to yield the unified security indication, e.g., a yes/no indication suggesting whether the device is being attacked or not. Alternatively, a plurality of threshold levels may be determined to indicate a plurality of levels of security. A detailed description of data analysis and decision making processes 222, 224 and 226 will be given hereinafter. Calculations of data analysis and decision making processes 222, 224 and 226 may be done in real time. Since the three processes 222, 224 and 226 are independent of each other, they may be executed substantially in parallel, depending, inter alia, on the computational power of the processing platform (e.g. cellular device 110 or central server 150).

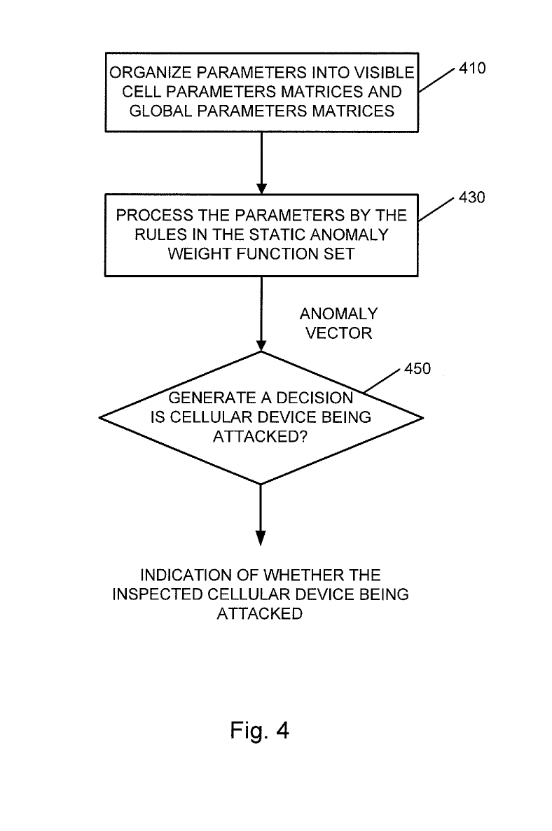

Reference is now made to FIG. 4 which is a flowchart illustration of an exemplary rule-based method for data analysis and decision according to embodiments of the present invention. In block 410 the status parameters or a subset of the status parameters related to a cell may be organized, for example, into a visible cell parameters (VCP) matrix and to global parameters matrix. For, example, the VCP matrix may include cell specific parameters, while the global parameters matrix may include global parameters. This step is optional and is directed to clarify and simplify the presentation and calculations. The VCP matrix may include, inter alia, present and past samples of, for example, cell identification (Cell ID), network identification (Net ID), signal strength, primary scrambling code, etc. the global parameters matrix may include, inter alia, samples of the location of the cell (Location), the position of the cellular device (Position), the status of the operating system of the cellular device, the link status etc. According to embodiments of the present invention, these status parameters may be sampled periodically, for example, every few seconds. A VCP matrix and a global parameters matrix may be built for every cell recognized by the inspected cellular device. The parameters, arranged, for example, in matrices as described hereinabove, may then be processed by the rules in the static anomaly weight (SAW) function set, as indicated in block 430. Typical rules calculate mathematical and statistical functions on the status parameters. Each of the rules of the SAW function set may increase or decrease a value of anomaly weight of a cell. The result of the calculation is anomaly vector, each component of anomaly vector may include weight indicative of the likelihood of an attack, such as a cell being “faked” (eavesdropping attack). The final stage may include some decision function to generate a decision, for example, a binary decision of “Yes/No” per cell from the anomaly vector, as indicated in block 450.

Sample rules are described hereinbelow. These are sample rules that represent the power of the rules language. Other suitable rules may be generated and used together or instead of the rules described hereinbelow. Rules may be generated by these skilled in the art based on prior knowledge of typical status parameters of legitimate cells and faked cells. sample rules may include:

Sample rule 1: A cell is faked if its “Cell ID” parameter contains a known ID of a faked cell. A list of such known faked cells may be obtained in advance and stored in the system. For example, some of the faked cell IDs are public.

Sample rule 2: A cell is faked If the signal strength(i)>C1*max{Signal Strength(j)} (for all j<>i), where i and j are cell indices, and C1 is a predetermined parameter, representing a common tendency of faked cells to faked exceptionally high signal strength indication. This rule may test if the signal strength of a cell is higher than signal strength of other cells. C1 may be in the range of, for example, 5-15, and may be adapted to a certain region by the system designer based, for example, on trail and error.

Sample rule 3: A cell is faked if its “Cell ID” parameter contains a known ID of a true cell AND the Location parameter does not match the known area in which the true cell having that “Cell ID” is known to be.

Each of the results of rules may be further processed by additional rules such as:

Sample rule 4: a cell is faked if its “a-normal” score is more than C2 times the “a-normal” score of other cells, where the “a-normal” score is calculated as a weighted sum of the indicators from the previous sample rules, with weights Al for rule number 1, A2 for rule number 2, and A3 for rule number 3. For example, each of the weights A1, A2, A3 may be in the range of 2-10 and C2 may be in the range of 2-4.

An indication of a faked cell may result in increasing of the anomaly weight of that cell by a predetermined value, else, the anomaly weight may be decreased by a predetermined value or remain the same. The decision function of block 450 may use the anomaly weight of a certain cell to determine if that cell is faked or not. An example for such decision function may be: if anomaly weight of cell (i)>C3 than cell (i) is faked, else if anomaly weight of cell (i)<C4 cell (i) is not faked, else cell (i) is suspicious. C3 and C4 may be predetermined parameters or may be parameters whose values are calculated with relation to the averaged anomaly weight of the cells.

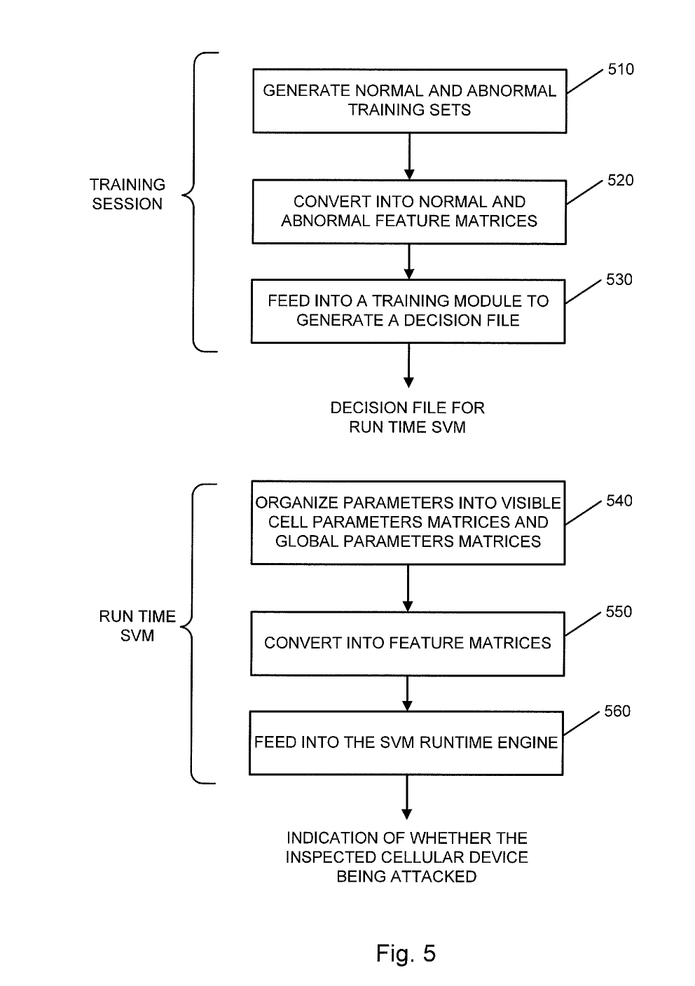

Reference is now made to FIG. 5 which is a flowchart illustration of an exemplary dynamic method for data analysis and decision making according to embodiments of the present invention. This method is based on support vector machine (SVM) and supervised learning. A decision file for the run time SVM may be generated at a training session preformed off-line, for example, at a central location such as central server 150. In block 510 normal and abnormal training sets of status parameters may be generated. For example, commercially available or especially made eavesdropping equipment may be used to generate “abnormal” scenarios from which status parameters may be derived. Similarly, legitimate cells of known operators may be sampled to generate “normal” status parameter sets. Additionally or alternatively, normal and abnormal parameters sets may be generated by simulation. The sets of normal and abnormal parameters may be organized into normal and abnormal VCP and global parameters matrices sets, where each scenario is represented by a set of VCP matrix and a global parameters matrix, similarly to block 410 of FIG. 4. In block 520, the normal and abnormal VCP and global parameters matrices sets may be turned into training feature matrices using a set of rules, where each set of VCP matrix and a global parameters matrix is turned to a single feature matrix, and wherein each of the feature matrices is marked as normal or abnormal.

Components of the feature matrix, referred to as features, are generated using rules applied on values of the status parameters (organized for simplicity in the VCP and global parameters matrices sets). The rules may be similar in nature to sample rules 1-4 presented hereinabove, however, instead of increasing or decreasing an anomaly weight, a feature value may be generated. For example, using sample rule 1, if a “Cell ID” parameter of a cell contains a known ID of a faked cell, a feature of that cell may be set to equal a first value, or else that feature may be set to equal a second value. Additionally or alternatively, these features may be generated by mathematical manipulations performed on the status parameters, or simply by using selected parameters as is.

In block 530, these normal and abnormal feature sets may be fed into the training module, which is adapted to generate a “decision file” for the runtime SVM engine. The “decision file” may be updated when new training sets are built—for example, after new eavesdropping equipment is sampled (abnormal set) or a new cell of a legitimate mobile operator is sampled (normal set).

At runtime, the sampled and gathered status parameters may be organized as a set of VCP matrix and a global parameters matrix, as indicated in block 540 and converted into a feature matrix using the same rules or manipulations used in block 520, as indicated in block 550. The feature matrix may be fed into the SVM runtime engine and a decision may be taken, as indicated in block 560. The SVM runtime engine may be implemented in some embodiments as a sequence of matrix multiplications.

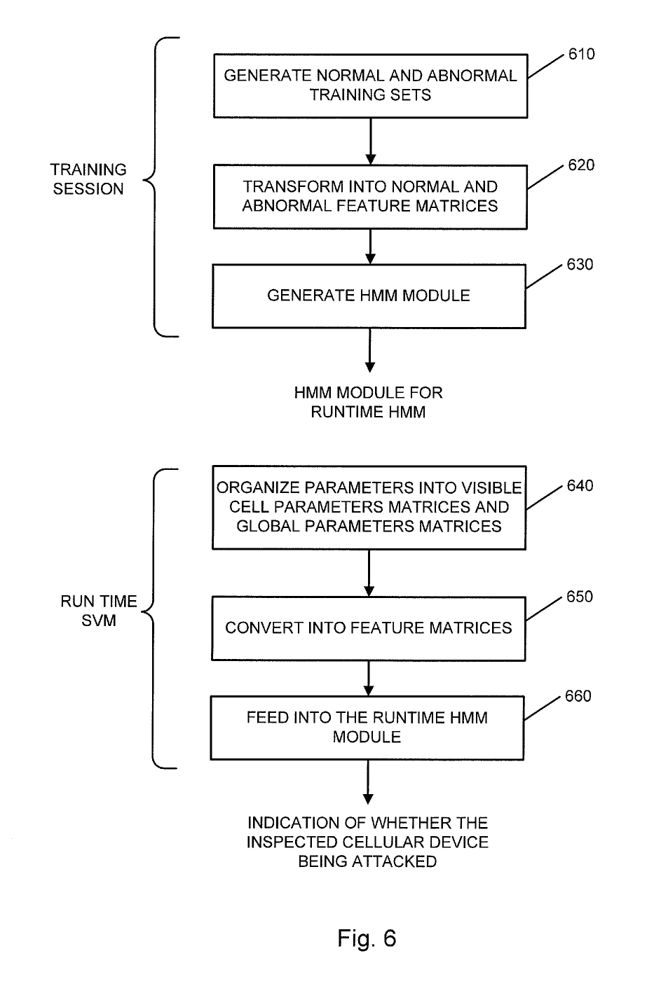

Reference is now made to FIG. 6 which is a flowchart illustration of an exemplary HHM method for data analysis and decision making according to embodiments of the present invention.

An HMM module may be generated at a training session preformed off-line, for example, at a central location such as central server 150. In block 610 normal and abnormal training sets of status parameters may be generated, similarly to block 510 of FIG. 5. The sets of normal and abnormal parameters may be organized into normal and abnormal VCP and global parameters matrices sets, similarly to block 410 of FIG. 4. In block 620, the normal and abnormal VCP and global parameters matrices sets may be turned into feature matrices, similarly to block 520 of FIG. 5.

In block 630, these normal and abnormal feature sets may be used, as well as other knowledge, to build the HMM module. As known in the art, building blocks of a HMM module may include states, possible observations, state transition probabilities and output probabilities. All these may be determined off-line, based, inter alia, on the training sets. For example, the states of the HMM may be defined as the states of the system that precede an eavesdropping event. For example if the inspected cellular device is sampled and parameters are received every 10 seconds, and the evidences of eavesdropping needs to be collected for 3 minutes, it follows that about 18 states (3×60/10) may be required for the HMM. These states may be recognized by data analysis of sequential training sets taken before and during known eavesdropping events, or manually by a person skilled in the art. The possible observations may be formed as feature matrices, for example, these build in block 620. State transition probabilities and output probabilities may be determined automatically and/or manually, by analyzing the training sets by dedicated computer software or by a person skilled in the art. The building blocks of the HMM module may be updated when new training sets are built—for example, after new eavesdropping equipment is sampled (abnormal set) or a new cell of a legitimate mobile operator is sampled (normal set).

At runtime, the sampled status parameters may be organized as a set of VCP matrix and a global parameters matrix, as indicated in block 640 and converted into a feature matrix using the same rules or manipulations used in block 620, as indicated in block 650. The feature matrix may be fed into the HMM module as runtime observations. The HMM may calculate the runtime probabilities for each state and these may be used, with relation to the state transition probabilities and output probabilities, calculated in advance in block 630, for determining the current state of the HMM module and for decision taking, as indicated in block 660.

It should be noted, that some of the steps of the rule based system, the runtime SVM engine and the HMM, may be unified. For example, sampled status parameters may be organized into the same set of VCP matrix and global parameters matrix for the three different algorithms. Alternatively, each algorithm may obtain as input different subset and arrangement of status parameters. Similarly, the rules based system and the SVM and HMM engines may use similar or different set of rules, and the SVM and HMM engines may use similar or different feature matrices. Additionally, the SVM and HMM engines may use same training sets.

Some embodiments of the present invention may be implemented in software for execution by a processor-based system, for example, detection unit 120. For example, embodiments of the present invention may be implemented in code and may be stored on a non-transitory storage medium having stored thereon instructions which can be used to program a system to perform the instructions. The non-transitory storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for monitoring security status of a cellular device engaged in a cellular network, the method comprising:
gathering status parameters related to the cellular device;
analyzing the status parameters; and
determining the security status of the cellular device based on the analysis.

2. The method of claim 1, wherein the status parameters are selected form the list consisting of: cell identification, cell label network identification, cell signal strength, primary scrambling code, location of the cell, Location Area Code, position of the cellular device, status of an operating system of the cellular device and link status and kernel hooks.

3. The method of claim 1, wherein analyzing the status parameters is performed using at least one analysis and machine decision making methods, the analysis and machine decision making methods are selected from the list consisting of: rule based system and machine learning methods.

4. The method of claim 3, wherein determining the security status comprises integrating results of the at least one analysis and machine decision making methods to a unified indication.

5. The method of claim 3, wherein the machine learning methods are selected from the list consisting of: support vector machines and hidden Markov models.

6. The method of claim 3, wherein analyzing the status parameters comprises:
analyzing the status parameters using a rule based system;
analyzing the status parameters using a support vector machine; and
analyzing the status parameters using a hidden Markov model.

7. The method of claim 6, wherein determining a security status comprises integrating the results of the rule based system, the support vector machine and the hidden Markov model to a unified indication.

8. The method of claim 6, wherein the rules of the rules based system are selected from the list consisting of:
rule 1: a cell is faked if its “Cell Identification” parameter contains a known identification of a faked cell,
rule 2: a cell is faked if its signal strength is higher than signal strength of other cells,
rule 3: a cell is faked if its “Cell Identification” parameter contains a known identification of a true cell and its Location parameter does not match a known area in which the true cell having that “Cell Identification” is known to be, and
rule 4: a cell is faked if its “a-normal” score is more than C2 times the “a-normal” score of other cells, where the “a-normal” score is calculated as a weighted sum of the indicators from the rules 1 to 3.

9. The method of claim 6, wherein analyzing the status parameters using the support vector machine comprises:
obtaining a runtime support vector engine comprising a decision file generated during a learning phase;
converting the status parameters into feature matrices using a set of rules; and
feeding the feature matrices into the runtime support vector engine.

10. The method of claim 6, wherein analyzing the status parameters using the hidden Markov model comprises:
obtaining a hidden Markov model module comprising a decision file generated during a learning phase;
converting the status parameters into feature matrices using a set of rules;
feeding the feature matrices into hidden Markov model module as runtime observations; and
determining a current state of the hidden Markov model module.

11. A data processing system comprising:
a processor; and
a computer usable medium connected to the processor, wherein the computer usable medium contains a set of instructions for monitoring security status of a cellular device engaged in a cellular network, wherein the processor is designed to carry out a set of instructions to:
gather status parameters related to the cellular device;
analyze the status parameters; and
determine a security status of the cellular device based on the analysis.

12. The data processing system of claim 11 wherein the status parameters are selected form the list consisting of: cell identification, cell label network identification, cell signal strength, primary scrambling code, location of the cell, Location Area Code, position of the cellular device, status of an operating system of the cellular device and link status and kernel hooks.

13. The data processing system of claim 11, wherein the processor is designed to carry out a set of instructions to analyze the status parameters using at least one analysis and machine decision making methods, the analysis and machine decision making methods are selected from the list consisting of: rule based system and machine learning methods.

14. The data processing system of claim 13, wherein the processor is designed to carry out a set of instructions to determine the security status by integrating results of the at least one analysis and machine decision making methods to a unified indication.

15. The data processing system of claim 13, wherein the machine learning methods are selected from the list consisting of: support vector machines and hidden Markov models.

16. The data processing system of claim 13, wherein the processor is designed to carry out a set of instructions to analyze the status parameters by:
analyzing the status parameters using a rule based system;
analyzing the status parameters using a support vector machine; and
analyzing the status parameters using a hidden Markov model.

17. The data processing system of claim 16, wherein the processor is designed to carry out a set of instructions to determine a security status by integrating the results of the rule based system, the support vector machine and the hidden Markov model to a unified indication.

18. The data processing system of claim 16, wherein the rules of the rules based system are selected from the list consisting of:
rule 1: a cell is faked if its “Cell Identification” parameter contains a known identification of a faked cell,
rule 2: a cell is faked if its signal strength is higher than signal strength of other cells,
rule 3: a cell is faked if its “Cell Identification” parameter contains a known identification of a true cell and its Location parameter does not match a known area in which the true cell having that “Cell Identification” is known to be, and
rule 4: a cell is faked if its “a-normal” score is more than C2 times the “a-normal” score of other cells, where the “a-normal” score is calculated as a weighted sum of the indicators from the rules 1 to 3.

19. The data processing system of claim 16, wherein the processor is designed to carry out a set of instructions to analyze the status parameters using the support vector machine by:
obtaining a runtime support vector engine comprising a decision file generated during a learning phase;
converting the status parameters into feature matrices using a set of rules; and
feeding the feature matrices into the runtime support vector engine.

20. The data processing system of claim 16, wherein the processor is designed to carry out a set of instructions to analyze the status parameters using the hidden Markov model by:
obtaining a hidden Markov model module comprising a decision file generated during a learning phase;
converting the status parameters into feature matrices using a set of rules;
feeding the feature matrices into hidden Markov model module as runtime observations; and
determining a current state of the hidden Markov model module.
